(19) United States
(12) Patent Application Publication
(10) Pub. No.: US 2005/0210853 A1
(43) Pub. Date: Sep. 29, 2005

(54) Pepper harvester

(76) Inventors: Ricky A. Massey, Animas, NM (US); Billy F. Massey, Animas, NM (US)

Correspondence Address: JACOBSON HOLMAN PLLC, 400 SEVENTH STREET N.W., SUITE 600, WASHINGTON, DC, 20004, US

(21) Appl. No.: 10/806,102

(22) Filed: Mar. 23, 2004

(51) Int. Cl. A01D 45/00

(52) U.S. Cl. 56/327.1

(57) ABSTRACT

A harvester to remove jalapeno peppers or similar chili peppers from the plants on which they grow. More specifically, the invention relates to a self-propelled, mechanical pepper harvester which includes a header at the forward end of the harvester having a plurality of picking units for picking peppers from a plurality of rows of pepper plants. Each of the picking units includes a pair of spaced longitudinally inclined picking bars oriented in opposed relation with opposite ends of the picking bars being connected eccentrically to rotatable disks for movement in an orbital path. The opposed picking bars include facing and opposed picking fingers which move cyclically in an upward and rearward path. The opposed picking fingers include spaced apart tip ends to enable the stem of the pepper plants to pass therebetween while stripping or removing the peppers from the plants. The picking bars, picking fingers and rotatable disks being transversely and downwardly inclined away from a row of pepper plants for discharging picked peppers laterally onto a conveying surface. A conveyor chain with paddles and L-shaped fingers thereon convey picked material to an air separation structure.

### BACKGROUND OF THE INVENTION

1. Field of the Invention

The present invention generally relates to harvesting peppers from the plants on which they grow. More specifically, the invention relates to a harvester for picking jalapeno peppers or similar chili peppers.

2. Description of the Prior Art

Harvesters of various types have been developed for picking various agricultural products from the plants on which they grow. Such developments include harvesters for picking jalapeno peppers or other similar chili peppers from the plants on which they grow with the picked peppers being cleaned of plant stalks, leaves and similar debris and then collected for further processing. Such harvesters have been developed due to elevated costs of picking peppers manually.

One known pepper harvesting apparatus is disclosed in U.S. Pat. No. 5,287,687 issued Feb. 22, 1994 and assigned to Colorado-Harvester, Inc. This patent, hereinafter referred to as the Colorado Harvester, utilizes row picking units each of which includes opposed fingers which move rearwardly and upwardly to engage, elevate and separate peppers from the pepper plant. The picked peppers are then conveyed to a collection area with the peppers being cleaned by separating plant stems, leaves and the like before depositing in a storage bin or other storage facility. Another prior patent disclosing picking fingers for removing peppers from pepper plants is U.S. Pat. No. 6,058,690 issued May 9, 2000. These patents and the prior art cited therein disclose various developments in the field of picking peppers and similar products from the plants on which they grow by utilizing multirow headers with multiple picking units incorporated therein for separating peppers from a plurality of rows of pepper plants. While relevant, the prior art does not disclose specific details incorporated into the present invention.

### SUMMARY OF THE INVENTION

The harvester of the present invention includes a wheeled vehicular structure that is power driven and controlled by an operator in a conventional manner. Such controls include directional control, speed control, header elevational control, picking unit drive control, control of conveyors and air cleaning of picked product when conveying to a storage area.

The header at the forward end of the harvester includes a plurality of picking units for picking peppers from a plurality. of rows of pepper plants. Each of the picking units includes spaced picking bars oriented in opposed relation with opposite ends of the picking bars being connected eccentrically to rotatable disks for movement in an orbit defined by the eccentric connection of the bars to the rotating disks. The opposed bars include facing and opposed picking fingers which move in the same path as the-bars. The forward disks are located at an elevation lower from the rearward disk so that the forward ends of the bars and the fingers thereon are oriented at an elevation lower than the rearward ends of the bars and the fingers mounted thereon. This structure moves the opposed fingers in an upward and rearward path. The opposed fingers are spaced apart to enable the stem of the pepper plants to pass therethrough while stripping or removing the peppers from the plants.

The fingers on the bar-incline upwardly in order that the picked peppers are deposited onto a generally flat surface and are moved along the flat surface by a paddle chain conveyor system for deposit of the peppers into conveyor structure at the rearward end of the picker head. The motion of the picker bars and fingers is generally known as a “hay rake motion” and is known in the Colorado Harvester patent which also uses opposed picking fingers of rubber or similar material. Unlike the Colorado Harvester in which the picking fingers overlap or interleave, the picking fingers on the picking bars of the present invention are spaced apart in opposed relation to provide an open area between the ends of the opposed fingers which provides space for the main stem of the pepper plants to pass through thereby reducing plant breakage and reducing the quantity of plant stems and leaves mixed with the harvested peppers which substantially reduces the efficiency of the conveying system throughout the harvester.

Accordingly, an object of the present invention is to provide a pepper harvester especially adapted for, but not limited to picking jalapeno peppers or similar chili peppers by using a more effective and less costly harvester thereby reducing the unit cost of picking peppers which enables the cost of picking peppers by machine less than the cost of manually picking peppers.

Another object of the present invention is to provide a pepper harvester in which opposed picking fingers are mounted on picking bars supported eccentrically at their ends by rotating members to move the bars and fingers in a hay rake motion in which the picking fingers are inclined upwardly and inwardly from the picking bars with the free ends of opposed fingers spaced apart to form an open area. The inclination of the fingers provides an inclined support for the picked peppers so that they roll down the inclined support onto a generally flat conveying surface to. enable the picked peppers to be moved to the rear to a conveying apparatus by a paddle chain conveyor in which the paddles are mounted on an endless driven chain to move the picked peppers into a transverse conveyor structure.

A further object of the invention is to provide a pepper harvester in accordance with the preceding object in which the area forwardly of the opposed picking fingers and picking bars is free of obstructions to enable the pepper plants to freely enter the open area between the picking fingers with the upward and rearward-movement of the opposed picking fingers effectively removing peppers from the pepper plants with the picking bars being of rigid hollow construction and the rotating members being in the form of disks of lightweight material to reduce the weight of the moving components while maintaining the strength and rigidity thereof.

Yet another object of the present invention is to provide a pepper harvester in accordance with the preceding objects in which each of the rotatable disks supports four picker bars with picking fingers thereon moving in a hay raking motion. The four eccentrically mounted picking bars and fingers moving in a hay rake motion enables the picking bars to move rearwardly and upwardly when in closest facing relation and downwardly and forwardly when in the remotest relation. The disks are inclined so that the moving picking bars and fingers provide a substantially continuous downwardly inclined surface. The inclined fingers convey the peppers being picked by the upwardly moving picking fingers downwardly and outwardly to a flat surface on which the peppers are moved to the rear by a paddle chain conveyor structure.

A still further object of the invention is to provide a pepper harvester in which the header supporting the picking units can be pivoted upwardly and downwardly about a pivot axis by a lifting and lowering structure located under the header which enables free flow of the picked peppers from the header into a conveying system.

These together with other objects and advantages which will become subsequently apparent reside in the details of construction and operation of the invention as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic side elevational view of the pepper harvester of the present invention.

FIG. 2 is a top plan view, on an enlarged scale, of the header with three row picking units being illustrated.

FIG. 3 is a detailed plan perspective view of the rearward upper end of a picking unit illustrating the association of the picking bars, picking fingers and rotating disks on which the picking bars are eccentrically connected.

FIG. 4 is a detailed plan perspective view of the forward end of the picking bars and picking fingers illustrating the inclination of the rotating disks to maintain the picking fingers in proper relationship during movement.

FIG. 5 is a detailed plan perspective view illustrating the drive mechanism for the paddle chain conveyor and picking bars at the rearward end of the header.

FIG. 6 is a schematic plan view of the drive mechanism for the picker bars and paddle chain conveyor.

FIG. 7 is a plan perspective view of the forward end of the header and picking units.

FIG. 8 is a schematic elevation view of the picking bars, picking fingers and disks illustrating the inclination thereof.

FIG. 9 is a schematic side elevational view of the picking bars and disks.

FIG. 10 is a schematic side elevational view of the harvester illustrating the operating components thereof.

FIG. 11 is a schematic view of the air separation of the plant stems and leaves from the picked peppers.

FIG. 12 is a schematic plan view of the rearward ends of the picker bars-and driving disks illustrating the relation of the four picker bars and driving disks.

### DESCRIPTION OF THE PREFERRED EMBODIMENTS

Although only one preferred embodiment of the invention is explained in detail, it is to be understood that the invention is not limited in its scope to the details of construction and arrangement of components set forth in the following description or illustrated in the drawings. The invention is capable of other embodiments and of being practiced or carried out in various ways.

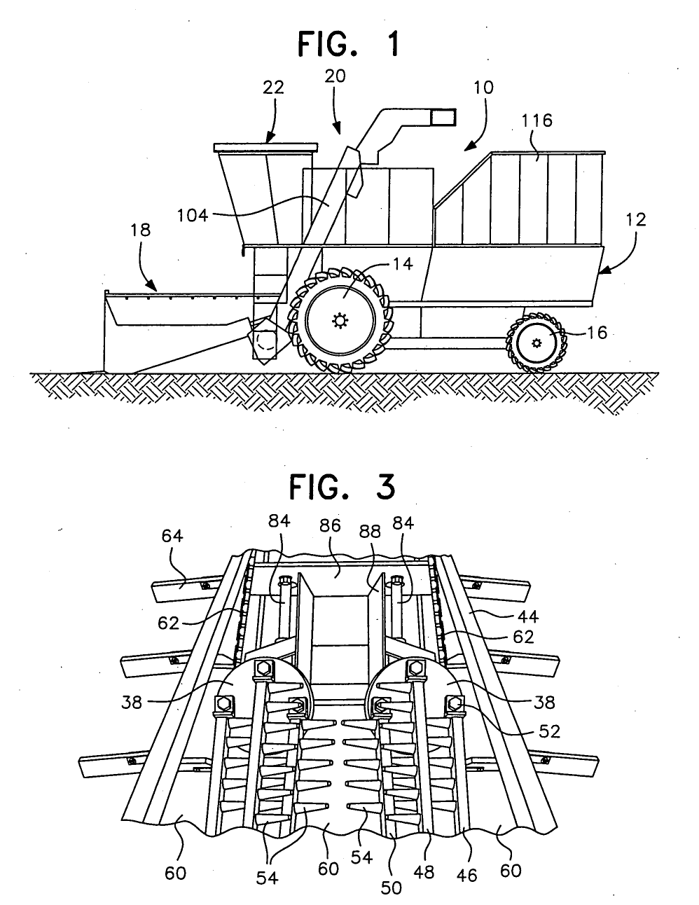

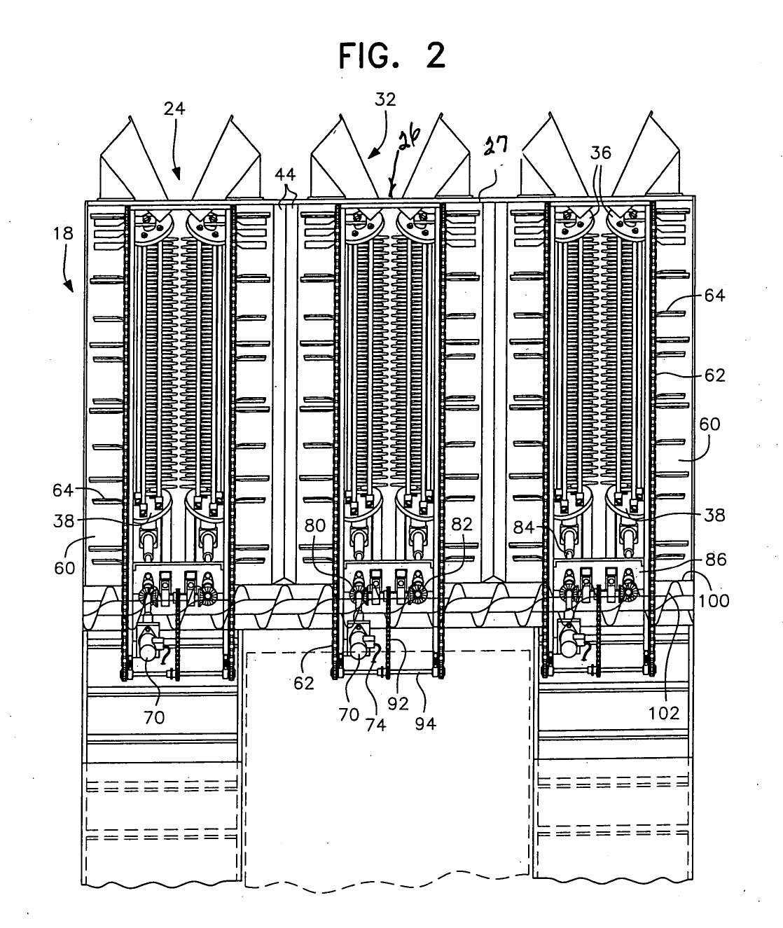

Referring to FIG. 1 of the drawings, the schematically illustrated pepper harvester is designated by reference numeral 10 and is in the form of a vehicular structure 12 including a rigid frame, front drive wheels 14, rear steerable wheels 16, a forwardly extending pepper picking header 18, a conveying and separating structure 20 and an operator's cab 22 including controls for controlling the direction of movement, speed of movement and other operational characteristics of the pepper harvester. Of primary significance in the present invention is the construction and operation of the picking header 18 which is shown in plan detail in FIG. 2. As illustrated, the picking header 18 includes three picking units 24 for picking peppers from three rows of pepper plants. The number of picking units 24 may vary since the relationship of the picking units 24 to the pepper plants is the same in each picking unit.

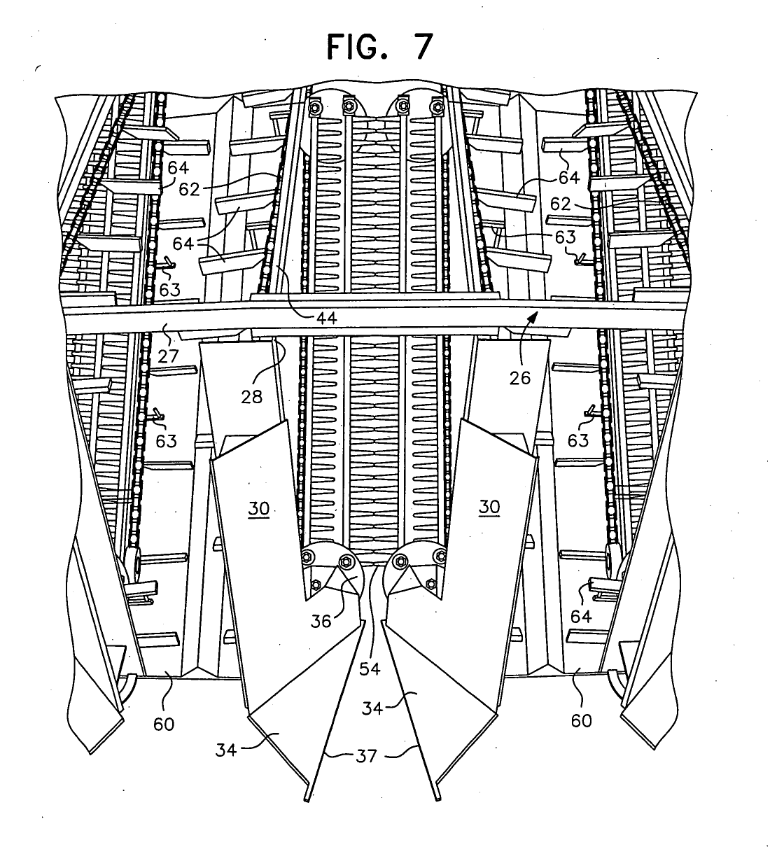

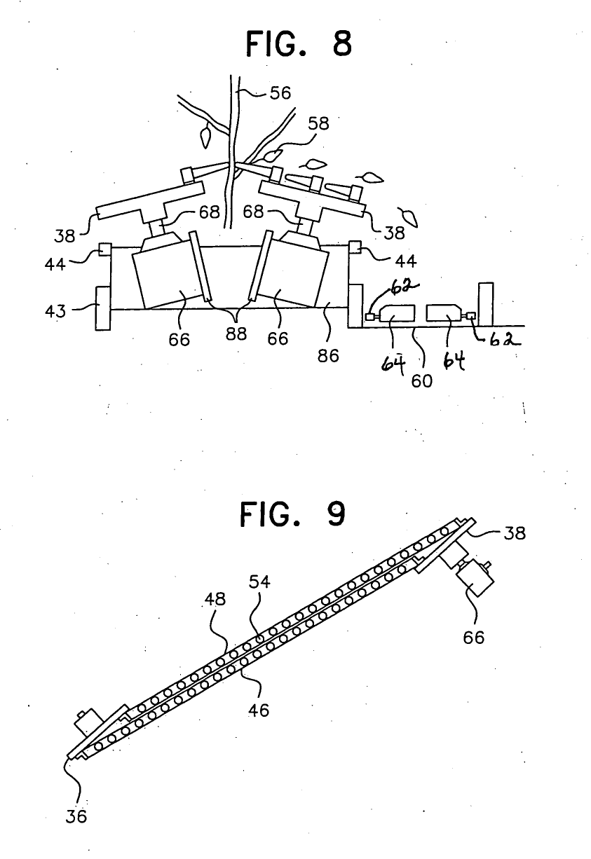

The picking header 18 includes a rigid frame structure 26 including top transverse frame members 27 and longitudinal frame members 43, 44 to form a rigid support structure supported forwardly of the vehicular structure 12. The frame 26 includes forward depending support members 28 arranged in pairs and rigid with frame members 27, 43 and 44 to support outwardly inclined vertical plates 30 which define an entrance area 32 for each picking unit 24 to guide the pepper plants 56 (see FIGS. 7 and 8) into the picking unit. The lower end of each inclined plate 30 is provided with a forwardly extending generally horizontal guide plate 34 having rearwardly converging edges 37 forwardly of the vertical plates 30 to engage the lower end portions of the main stem or stalk of pepper plants to guide them into the picking unit 24.

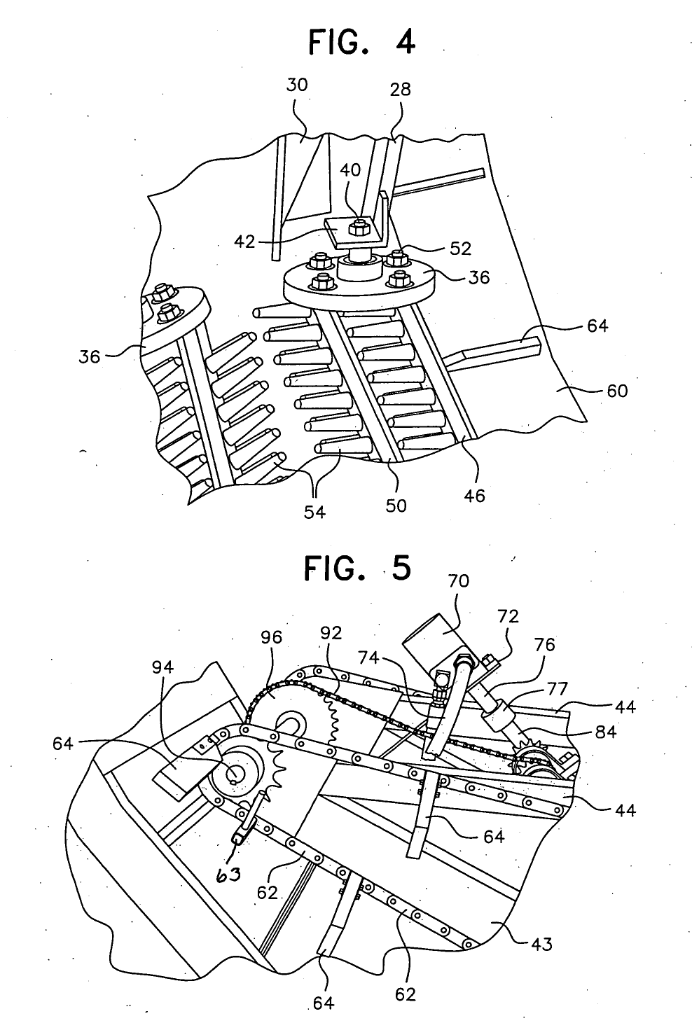

Each of the picking units 24 includes a pair of circular disks 36 at the forward end of the picking unit and a pair of circular disks 38 at the rearward end thereof. As illustrated in FIGS. 3 and 4, the forward disks are rotatably supported from a support bolt 40 secured to projecting lug 42 on a support member 28. The rearward disks 38 are supported from frame members 43 and 44 about a rotational axis parallel to the rotational axis of the forward disk 36 thereby orienting the disks 36 and 38 in parallel relation.

The circular disks 36 and 38 are interconnected by four picker bars 46, 47, 48 and 50 as illustrated in FIG. 12. The picker bars 46, 47, 48 and 50 are parallel to each other and the disks 36 and 38. The opposite ends of the picker bars are pivoted to the disks 36 and 38 at eccentric points equally spaced from the rotational axis thereof by a pivotal connection 52. As illustrated in FIGS. 4 and 8, the disks 36 and 38 are inclined on a slight angle of about 10-15 degrees. The rotational axes of the disks 36 and 38 diverge upwardly to maintain outward portions of the periphery of each of the disks lower than inward portions of the periphery. This results in the parallel picker bars 46, 47, 48 and 50 being of different elevations during their movement in a hay raking motion as illustrated in FIGS. 9 and 12. FIG. 9 also illustrates the inclination of the picking bars 46, 47, 48 and 50 between their forward ends and their rearward ends and the parallelism of the disks 36 and 38 and the picking bars 46, 47, 48 and 50. As illustrated in FIGS. 8, 9 and 12, the disks 36 and 38 are inclined and parallel and the picking bars 46, 47, 48 and 50 are also inclined longitudinally and are parallel to each other and move in an orbital path as determined by the movement of the pivotal connections 52. This structure enables the picking bars to move past each other when the picking bars are at different elevations as determined by the inclination of the rotational axes of disks 36 and 38.

Each of the picking bars includes a plurality of picking fingers 54 which are parallel to each other and parallel to the picking bars and disks 36 and 38. The disks 36, 38, picking bars 46, 47, 48 and 50 and fingers on one side of a picking unit being in the same upwardly and inwardly inclined plane as illustrated in FIG. 8. As illustrated in FIGS. 3 and 4, the picking fingers 54 taper to their outer tip ends. The outer tip ends of the fingers terminate in laterally spaced relation when they are in opposed relation and moving rearwardly and upwardly in parallel paths from a forward position to their rearward position as the picking bars orbit while in parallel relation to each other as the disks 36 and 38 rotate about their inclined axis. This arrangement of picking bars, support disks and picking fingers moves the picking fingers in an inclined hay raking motion. This provides an open area between the tip ends of opposed picking fingers to enable passage of the pepper plant stalk 56 downwardly between the inwardly extending inclined picking fingers as the picking fingers move vertically during their rearward movement. Also, as illustrated in FIGS. 8 and 12, the four inclined picking bars, inclined disks 36 and 38 and the inclined picking fingers provide a generally continuous inclined surface area from a point adjacent the stalk 56 of the pepper plant 56 so that peppers 58 which are removed from the pepper plant by the picking fingers 54 will tumble, roll, fall or migrate laterally outwardly in relation to the disks 36 and 38, the picking bars 46, 47, 48 and 50 and fingers 54 onto a flat conveying surface 60 below the picking bars as illustrated in FIG. 8.

This structure enables a chain conveyor 62 with lateral paddles 64 thereon to engage and move the peppers 58 which are deposited on the flat surface 60 in a manner illustrated in FIG. 8. The chain conveyor 62 and paddles 64 are provided on each side of each picking unit 24 thus moving all of the picked peppers 58 toward the rear of the flat surfaces 60. Also illustrated in FIG. 8 is a gear reduction drive unit 66 having an inclined output shaft 68 for driving each of the disks 38 about an inclined axis with the picking bars 46, 47, 48 and 50 rotating the disks 36 about an axis having the same inclination as the axis of rotation of disks 38. Each of the gear units 66 may be supported by brackets 88 that are supported from plate 86. The edges of plate 86 are supported at the top by top frame member 44 and at the bottom by lower frame members 43.

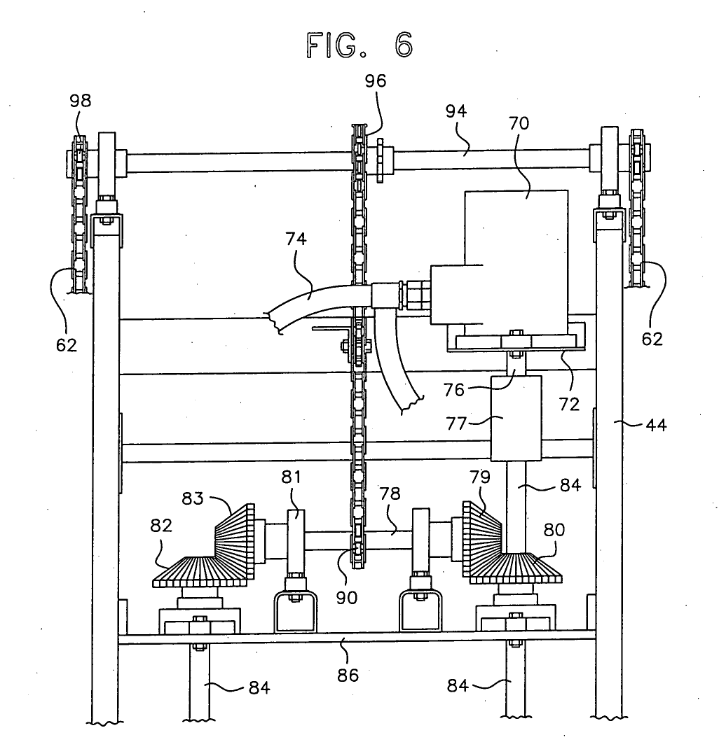

FIGS. 5, 6 and 8 illustrate the drive structure for the disks 36 and 38 as well as the chain paddle conveyor 62 which includes a hydraulic drive motor 70 supported from a bracket 72 supported from the frame structure 44 and provided with hoses 74 to enable supply and return of hydraulic pressure to the motor 70. The motor 70 includes an output shaft 76 drivingly connected to a drive shaft 84 through a drive coupler 77. A miter gear 80 on shaft 84 drives a transverse shaft 78 by miter gear 79 as shown in FIG. 6. The shaft 84 extends through the miter gear 80 and extends into one of the gear units 66 for driving the output shaft 68 that is connected to a disk 38. The transverse shaft 78 is supported in bearing blocks 81 and includes a miter gear assembly 82 and 83 at the opposite end thereof which drives an output shaft 84 connected with the other gear unit 66 for driving the other disk 38. This structure provides rotational movement of the disks 38 at the rearward end of the picking bars 46, 47, 48 and 50. The relationship of the drive shafts 84 from miter gears 80 and 82 to the disks 38 is illustrated in FIGS. 3 and 6 with the shafts 84 extending through a transverse frame member 86. A pair of guide plates 88 protects the rotating shafts 84 from entanglement with plants passing rearwardly between the picking fingers 54 as the harvester advances.

The transverse shaft 78 includes a centrally located sprocket gear 90 thereon between the bearing blocks 81 for driving a chain 92 which drives a transverse shaft 94 having a sprocket gear 96 thereon with the shaft 94 extending outwardly beyond the frame and including a sprocket gear 98 on each end thereof for driving engagement with the paddle chain conveyor 62.

As illustrated in FIG. 2, the flat surface 60 on which the sprocket chain 62 and paddles 64 are associated terminate just rearwardly of the disks 38 and just forwardly of the support plate 86 for the shafts 84 with the terminal edge of the flat surface 60 being designated by reference numeral 100. This enables the-peppers which have been picked to drop into a transverse auger conveyor 102 which conveys the peppers laterally into an upwardly inclined cleated belt conveyor 104 which forms part of the conveying and separating structure 20. In view of the tendency of broken limbs and branches to drop onto the conveying surfaces 60 and the paddles 64 pulling the broken limbs or stems or branches toward the traverse convey. Movement of the limbs, stems or leaves into the traverse conveyor is assisted by the use of protruding fingers 63 on chains 62. The fingers 63 are L-shaped with one leg attached to and protruding laterally from the chain 62. The other leg of fingers 63 extend upwardly from the chain 62 as the paddles 64 move rearwardly along surfaces 60 to assist in conveying stems, leaves and limbs toward the transverse conveyor 102. Fingers 63 are oriented between every other paddle 64. The upwardly extending leg of each finger 63 is inverted as the chain 62 moves around sprocket gear 98 so that the free end of the vertically extending leg of finger 63 is pointing downwardly for discharge of any leaves, limbs or stems carried by the fingers 63 into the transverse conveyor 102.

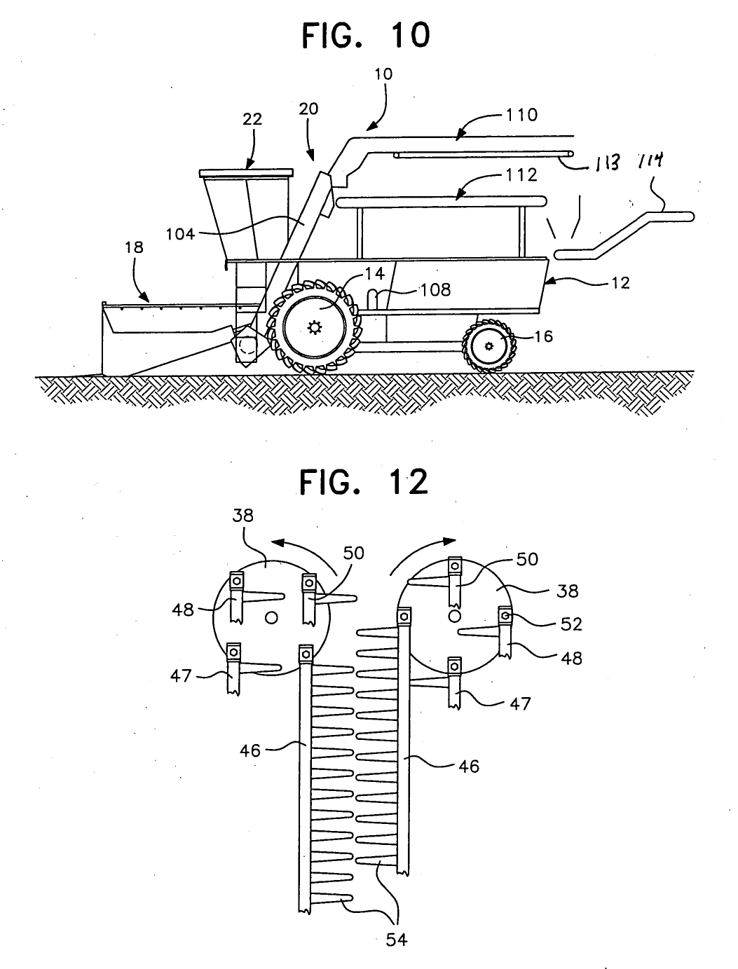

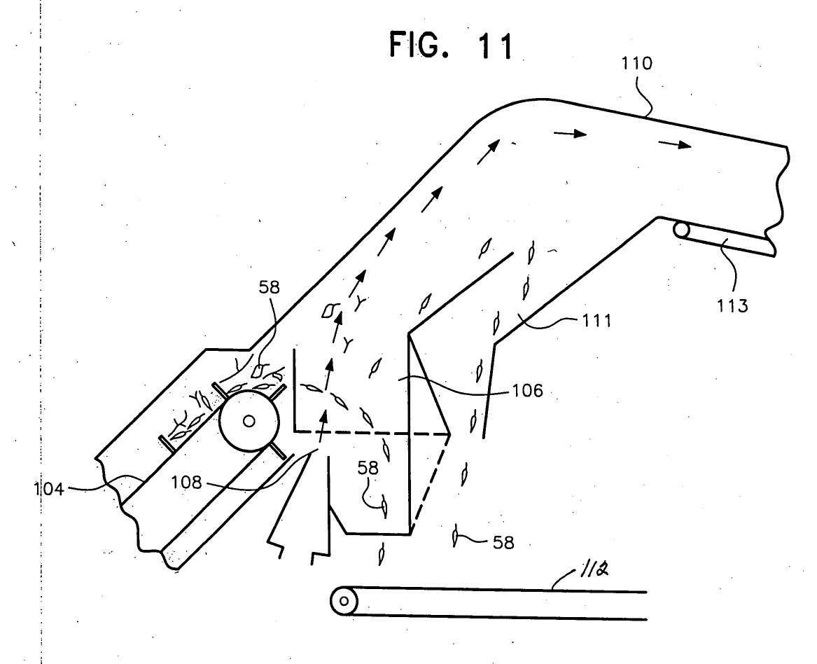

As schematically illustrated in FIGS. 10 and 11, the inclined conveyor 104 discharges the peppers in a separating chamber 106 having a high velocity air flow passing upwardly therethrough at 108 to separate leaves and stems which move upwardly into an exhaust chute 110. In the event any picked peppers move into the direction of the exhaust chute, a secondary separation chamber 111 is provided so that as the velocity of the air reduces entering the exhaust chute 110, any picked peppers 58 that may be entrained therein will fall downwardly into the separation chamber 111. Both separation chambers 106 and 111 discharge onto a sorting conveyor 112 at which position a sorter may manually pick and throw out any leaves or stems that may still accompany the picked peppers. From the sorting conveyor 112, the peppers are discharged to an unloading conveyor 114 which deposits the peppers in a storage area, bin or trailing vehicle.

FIG. 10 illustrates schematically the relationship of the header 18, vehicular structure 12, operator's cab 22, conveyor 104, air source 108 including a fan, the exhaust chute 110, sorting conveyor 112 and unloading conveyor 114. As shown in FIG. 11, exhaust chute 110 is provided with a conveyor 113 forming a bottom for chute 110 to quickly discharge leaves and other debris.

An important feature of the invention is the structure, orientation and operation of the rotating disks 36 and 38, the picking bars and the picking fingers combined with the flat .surfaces 60 on which the picked peppers drop and conveyed to a rear transverse conveyor by a paddle chain conveyor. As illustrated in FIG. 8, the opposing picking units including the rotating disks, the orientation of the picking bars and the orientation of the picking fingers is at a transverse angle of 10-15 degrees. This provides a more effective picking angle for the fingers as they enter the plant at a slight upward angle helping to disengage the pepper pods from the plants. When the pods are free from the plant, they are carried on top of the upwardly and transversely inclined fingers and bars and the momentum of the peppers provided by the hay rake motion moves the peppers along with the transverse incline of the picking fingers and bars onto the flat surface 60 to be conveyed as illustrated in FIG. 8.

As the picking bar moves in a hay raking motion and as the ends thereof travel in an inclined circular path with the connection to the disks, the picked pods 58 are delivered to the conveyor surface 60. Inasmuch as the bars are set on a longitudinal angle, gravity is also used to help move the picked pepper pods 58 onto the conveyor surface 60 so that the paddles 64 on the chain conveyor can move the pods effectively toward the rear and into a transverse auger conveyor 102 for discharge onto and upwardly inclined cleated belt conveyor 104 through a two stage air separation for separating any residual leaves or stems from the pepper pods 58 which are discharged onto a sorting conveyor 112 and then onto an unloading conveyor 114 with the separated leaves and stems being discharged to atmosphere and back onto the ground surface.

This structural arrangement enables high speed movement of the bars and picking fingers in their hay raking motion to increase the effectiveness of the fingers picking the peppers from the plants in order for the machine to pick at a more efficient and more profitable rate. The angle of the picking bars and fingers also allows the picking units to mirror the row on which the peppers are grown. The lowest fingers at the forward ends of the bars enter the base of the plant, picking the bottom pods which have always been the hardest part of the crop to harvest.

The picking bars and picking fingers have an open area between the ends of opposed fingers and the timing of the bars so that as one bar extends, the bar on the opposite side of the row retracts at the same time. Therefore, the open area neither gets larger or smaller and allows room for the plant's main stem 56 to pass through the open area thereby reducing plant breakage. The structure for powering the row units is unique with each side of each separate row unit being powered by a single hydraulic motor through a series of beveled gears and enclosed gear boxes which provides the timing of the picking bars. The paddle chain conveyors 62 on each side of each row unit are also powered from the same motor by sprockets and chains. The hydraulic motor provides a safety factor by stopping when a blockage occurs thereby preventing damage to the picking unit.

The pod conveying system includes chains 62 with paddles 64 mounted thereon which allows the row units to be much closer to the ground since the entire structure is located above the flat conveying surfaces 60. The paddles 64 run longitudinally of the flat conveying surface 60 and move up the incline at the rear thereof for discharge of the pods 58 into the transverse conveyor 102.

The foregoing is considered as illustrative only of the principles of the invention. Since numerous modifications and changes will readily occur to those skilled in the art, it is not desired to limit the invention to the exact construction and operation shown and described. Accordingly, all suitable modifications and equivalents may be resorted to, falling within the scope of the invention.

1. A pepper harvester comprising an operator controlled vehicular structure capable of movement along rows of pepper plants having mature pods thereon, said vehicular structure including a forwardly extending header with generally parallel row picking units mounted thereon, each picking unit comprising a plurality of generally parallel picking bars moving in an orbital path a rotatable support member connected to each of the forward and rearward ends of said picking bars, a plurality of picking fingers extending laterally from one side of each of said picking bars, said picking bars being oriented with a leading end lower than a trailing end, each of said bars being moved longitudinally during rotation of the rotatable support members a distance equal to the diameter of the rotational movement of each end of the picker bars to move the picking fingers an increment of vertical and longitudinal movement during each cycle of orbital movement, said picking fingers on opposed picking bars being disposed in opposed relation to enter a pepper plant from opposite sides at a low elevation, each of said opposed picking fingers terminating in tip ends that are laterally spaced from each other and generally in laterally aligned relation when moving upwardly in relation to pepper plants as the picking units move forwardly thereby enabling the pepper plant and branches to be pulled through the space between the picking fingers to remove pepper pods from the pepper plants, the orbital movement of the picking bars and picking fingers and the rotational speed of the rotatable support members being such that the picking fingers move vertically in relation to the pepper plants as the picking fingers move in an orbital path in relation to the pepper plants.

2. The harvester as claimed in claim 1 wherein said rotatable support members are lightweight circular disks, each of said picking bars being of hollow rigid construction and each of said picking fingers being of tapered resilient construction.

3. The harvester as claimed in claim 1 wherein said rotatable support members are driven by a hydraulic motor that is safely stopped if the harvester becomes jammed.

4. The harvester as claimed in claim 1 wherein said picking fingers, said picking bars and rotatable support members include upper surfaces that are inclined upwardly toward said pepper plants to form a laterally inclined supporting path of movement for peppers removed from the pepper plants.

5. A pepper harvester comprising an operator controlled vehicular structure capable of movement along rows of pepper plants having mature pods thereon, said vehicular structure including a forwardly extending header with generally parallel row picking units mounted thereon, each picking unit comprising a plurality of generally parallel picking bars moving in an orbital path a rotatable support member connected to the forward and rearward ends of said picking bars, a plurality of picking fingers extending laterally from one side of each of said picking bars, said picking bars being oriented with a leading end lower than a trailing end, each of said bars being moved an increment of vertical and longitudinal movement during each cycle of orbital movement, said picking fingers on opposed picking bars being disposed in opposed relation to enter a pepper plant from opposite sides at a low elevation, each of said opposed picking fingers terminating in tip ends that are laterally spaced from each other and generally in laterally aligned relation when moving upwardly in relation to pepper plants as the picking units move forwardly thereby enabling the pepper plant and branches to be pulled through the space between the picking fingers to remove pepper pods from the pepper plants, the orbital movement of the picking bars and picking fingers and the rotational speed of the rotatable support members being such that the picking fingers move vertically in relation to the pepper plants as the picking fingers move in an orbital path in relation to the pepper plants;
said picking fingers, said picking bars and rotatable support members including upper surfaces that are inclined upwardly toward said pepper plants to form a laterally inclined supporting path of movement for peppers removed from the pepper plants; and
each picking unit including a flat conveyor surface laterally of said picking bars to receive removed peppers from said inclined supporting path of movement for peppers removed from the pepper plants, and a chain conveyor adjacent said flat conveyor surface, said chain conveyor being moveable along said flat conveyor surface to move peppers removed from pepper plants rearwardly on said flat conveyor surface.

6. The harvester as claimed in claim 5 wherein said flat conveyor surface includes an upwardly inclined surface at its rearward end, a transverse conveyor in communication with the rearward end of the flat conveyor surface for receiving peppers moved rearwardly by said chain conveyor and transporting peppers transversely of said header.

7. The harvester as claimed in claim 6 wherein said vehicular structure includes an upwardly extending elevator receiving peppers from said transverse conveyor and discharging them through an air separator onto a sorting conveyor, said air separator including a source of moving air to remove plant leaves and stems as peppers pass through the moving air onto said sorting conveyor, a sorting station alongside said sorting conveyor to enable sorting personnel to manually remove residual plant leaves and stems, and a loading conveyor receiving cleaned peppers from said sorting conveyor to load peppers into a collection area.

8. The harvester as claimed in claim 1 wherein each said picking unit includes forwardly extending, outwardly inclined guides spaced laterally from each other to provide an unobstructed access of pepper plants to said opposed picking fingers, said picking fingers on said picking bars being inclined upwardly to convey peppers picked from pepper plants transversely of said picking bars and fingers into a longitudinal conveying structure alongside said picking unit to convey peppers to a rearward portion of said header.

9. (canceled)

10. A harvester for removing pod-like products from plants comprising a powered, operator controlled vehicle, a header supported from said vehicle and extending forwardly therefrom, spaced picking means mounted on said header, said picking means comprising longitudinally spaced apart rotatably driven support members, a plurality of elongated picking bars eccentrically connected to and extending between said rotatable support members, a plurality of spaced fingers secured to said bars and projecting laterally therefrom, said bars being inclined longitudinally with a forward end positioned lower than a rearward end such that said fingers on said bars move towards each other and simultaneously move upwardly when moving to the rear so as to engage said pod-like products and separate them from the plants on which they grow, said bars, fingers thereon and rotatable support members being parallel and inclined upwardly and toward said plants to move said bars and fingers thereon in an orbital vertical and laterally inclined path for moving said products laterally of said picking means and onto conveyor means conveying said pod-like products away from said picking means.

11. The harvester as claimed in claim 10 wherein said plurality of picking bars are eccentrically connected to said support members such that the bars are moved in an orbital path with a portion of the path being closer to the plants being picked when the bars are moving toward the rear of the header.

12. The harvester as claimed in claim 11 wherein said picking bars are moved rearwardly and upwardly when opposed bars and fingers are moved rearwardly with the rearward movement of the picking bars and picking fingers thereon moving a distance equal to the diameter of the rotational movement of the connection between the ends of the picking bars and the rotatable support members.

13. The harvester as claimed in claim 11 wherein each picking bar includes an increment of longitudinal movement and lateral inward and outward movement equal to the diameter of rotational movement of the connections between the ends of the picking bars and the rotatable support members.

14. The harvester as claimed in claim 13 wherein said rotatable support members are lightweight disks, said picking bars are tubular structural members of rigid construction and said picking fingers being transversely and upwardly inclined toward said plants at an angle such that pod-like products will roll from one picking bar to adjacent generally parallel picking bars onto said conveyor means as the picking bars oscillate in their orbital path of movement.

15. A method of harvesting peppers from pepper plants comprising the steps of providing picking fingers disposed on opposite sides of a row of plants, moving said fingers in an orbital path in a manner such that said fingers move cyclically upwardly and downwardly, toward and away from each other and forwardly and rearwardly to engage said peppers and separate them from said plants, the fingers on opposite sides of said plants being mounted on elongated picker bars each having a plurality of said fingers secured thereto, a pair of rotatable support members connected to the ends of each picking bar with the ends of the picking bar being eccentrically connected to said support members, said picking bars and rotatable support members being inclined upwardly and outwardly to move the picking bars and fingers toward the plant and simultaneously move said picking fingers upwardly and then move said picking fingers away from the plant and then simultaneously move away from the plant and downwardly and inclining downwardly and outwardly to pick peppers from the plants and transfer them laterally and downwardly onto a longitudinal conveying means to convey the peppers to a cleaner assembly.

16. A picking unit for harvesting pod products from row plants comprising at least one pair of parallel picking bars oriented on opposite sides of a row of plants, a driven rotatable support member at each end of each picking bar, each picking bar including forward and rearward ends connected to said support members in equally spaced relation to an axis of rotation of each rotatable support member to move said picking bars in an orbital path on opposite sides of a row of plants, a plurality of laterally extending picking fingers on each picking bar such that said fingers on each bar move cyclically toward and away from a row of plants, said rotatable support members at rearward ends of said picking bars being located above said rotatable support members at forward ends of said bars such that said picking fingers move vertically upwardly during cyclical longitudinal movement thereof when said picking fingers have been moved toward each other and toward a row of plants to extend under pod products on a row of plants and moving said fingers vertically to engage and move pod products upwardly and separate the pod products from the plants in a row as the picking unit is moved longitudinally along a row of plants, said picking fingers on said opposed picking bars having opposed tip ends in transverse alignment and laterally spaced apart to enable passage of plant stems in a row of plants to pass between said tip ends and adjacent surfaces of said picking fingers during upward and longitudinal movement of said picking fingers when said picking bars and picking fingers are moving in that part of said orbital path in closest opposed relation to remove pod products from a row of plants by moving opposed picking fingers upwardly through the plants.

17. The picking unit as claimed in claim 16 wherein said picking fingers, said picking bars and said rotatable support members incline upwardly towards said plants and toward said tip ends of the fingers thereof to provide an inclined support for pods removed from a row of plants for moving said pods laterally toward a conveying structure parallel to and below said picking bars and the tip ends of said fingers that are moving forwardly said opposed picking bars for discharge into a conveyor structure.

18. The picking unit as claimed in claim 17 wherein said picking bars are inclined longitudinally.

19. The picking unit as claimed in claim 17 wherein said picking fingers, picking bars and rotatable support members are inclined laterally about 10 to 15.
